(19) United States
(12) Patent Application Publication
(10) Pub. No.: US 2015/0078860 A1
(43) Pub. Date: Mar. 19, 2015

(54) Apparatus for Mounting Enclosures and Fixtures and Electronics Contained Therein

(71) Applicant: Jeffrey S. Ellingson, Woodbury, MN (US)

(72) Inventor: Jeffrey S. Ellingson, Woodbury, MN (US)

(21) Appl. No.: 14/489,413

(22) Filed: Sep. 17, 2014

Related U.S. Application Data
(60) Provisional application No. 61/878,629, filed on Sep. 17, 2013.

(51) Int. Cl. F16B 33/02; F16B 35/06; F16B 43/00

(52) U.S. Cl. CPC F16B 33/02; F16B 43/00; F16B 35/06
USPC 411/368

(57) ABSTRACT

A stud for mounting an enclosure having a body with a first diameter, a length, a top, and a bottom. A head is connected to the top of the cylindrical body and extends beyond an outer surface of the cylindrical body. A cylindrical extension is connected to the bottom of the cylindrical body having a second diameter less than the first diameter, and an outer surface of the cylindrical extension is threaded. The cylindrical body includes a threaded cylindrical bore having an opening in the top of the cylindrical body, and the threaded cylindrical bore extends into the cylindrical body.

### CROSS-REFERENCE TO RELATED APPLICATION

This patent application claims priority to provisional patent application entitled “Double Stud” filed on Sep. 17, 2013, having Ser. No. 61/878,629, which is hereby incorporated by reference.

### BACKGROUND OF THE INVENTION

1. Field of the Invention

The present invention relates generally to mounting fixtures, and more particularly, to an apparatus for mounting enclosures, such as watertight enclosures containing electronics.

2. Description of Related Art

Current UL50 and UL508A standards require electrical enclosures to be supplied with mounting hardware that is used to mount the enclosure sub panel to the back of the enclosure wall. This is typically accomplished using a weld on panel studs. UL50 and UL508A standards also require that enclosure manufactures supply means for mounting an enclosure by an electrician using basic tools. The cheapest way for a manufacturer to meet the UL50 and UL508A standards is to include holes in the back of an enclosure and a bag of nuts, bolts and gaskets, in hopes that the electrician installs the gaskets correctly and water does not leak into the enclosure during the life of the enclosure installation which could last over 30 years.

One of the problems with just providing mounting holes in the back of the enclosure is that the electrical sub panel may be required to be removed prior to mounting the enclosure which can require hours of extra electrical labor if the electrician has to unwire pushbuttons and or other electrical devices that may be mounted on the enclosure door, and then re-wire and test the devices after the enclosure is mounted, and the sub panel reinstalled. If the electrician installing the enclosure is in a high risk wash-down area, a welding contractor is often hired to weld the mounting holes closed, and then weld on a bracket that the electrician can use to properly install the enclosure without removing the back panel in the enclosure.

Accordingly, there is a need for a more efficient and reliable apparatus for mounting fixtures, enclosures, watertight enclosures, and the electronics contained inside.

### ASPECTS AND SUMMARY OF THE PRESENT INVENTION

One aspect of the present invention is to provide a more time efficient and adaptable apparatus for mounting watertight enclosures and electronics contained therein.

Another aspect of the present invention is to provide a more time efficient and adaptable apparatus for mounting general fixtures and enclosures, and components contained therein.

An additional aspect of the present invention is to provide a mounting apparatus that does not require electronics contained within an enclosure to be disconnected or remounted from their mounting surface, such as a sub panel, during the process of mounting the enclosure to a vertical wall.

A further aspect of the present invention is to provide a mounting apparatus that facilitates mounting an enclosure to a wall.

An additional aspect of the present invention is to provide a mounting apparatus that more reliably maintains a watertight seal of a watertight enclosure.

In order to achieve these aspects and others, the present invention provides a dual purpose fastener or stud that is installed and welded or otherwise secured onto the back of an enclosure, which still enables an electrician to mount a sub panel from inside of the enclosure, while mounting the enclosure itself from the outside, and further, without removing the enclosure sub panel. The present invention further eliminates the need for electricians to install gaskets to seal mounting holes because the fastener is welded in place, eliminating the requirements of special enclosure mounting gaskets and hardware. Additional mounting hardware can be included to mount the enclosure as close as one inch or less off the back of a wall or adjoining surface to as much as four inches or more of overall clearance, which is required for enclosure installations in food plants.

The fastener, stud, or apparatus of the present invention meets the requirements for UL50 and UL508A and associations of Underwriters Laboratories, Inc. (“UL”), Canadian Standards Association (“CSA”), and Association of Standardization and Certification (“ANCE”). The apparatus of the present invention, sometimes referred to by the inventor as a the Double Stud™ fastener, can be used on all types of fixtures and electrical UL50 enclosures, including enclosures for indoor locations (Types: 1, 2, 5, 12K and 13) or (NEMA: 1, 2, 5, 12K and 13), and enclosures for indoor and outdoor locations (Types 3, 3R, 3S, 4 4X, 6 and 6P) or (NEMA: 3, 3R, 3S, 4, 4X, 6 and 6P).

Accordingly, the present invention provides a stud or fastener for mounting an enclosure having a body with a first diameter, a length, a top, and a bottom. A head is connected to the top of the cylindrical body and extends beyond an outer surface of the cylindrical body. A cylindrical extension is connected to the bottom of the cylindrical body having a second diameter less than the first diameter, and an outer surface of the cylindrical extension is threaded. The cylindrical body includes a threaded cylindrical bore having an opening in the top of the cylindrical body, and the threaded cylindrical bore extends into the cylindrical body.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed invention and specific embodiments as a basis for designing or modifying other structures for carrying out the same purposes of the present invention, and that such other structures do not depart from the spirit and scope of the invention in its broadest form.

### BRIEF DESCRIPTION OF THE DRAWINGS

FIG. 1a is a perspective view of a mounting apparatus configured in accordance with a preferred embodiment of the present invention;

FIG. 1b is a top view of the mounting apparatus shown in FIG. 1a;

FIG. 1c is a cross-sectional view of the mounting apparatus shown in and taken along line 1c-1c of FIG. 1b;

FIG. 2a is a perspective view of a mounting apparatus configured in accordance with another embodiment of the present invention;

FIG. 2b is a top view of the mounting apparatus shown in FIG. 2a;

FIG. 2c is a cross-sectional view of the mounting apparatus shown in and taken along line 2c-2c of FIG. 2b;

FIG. 3a is a perspective view of a mounting apparatus configured in accordance with a further embodiment of the present invention;

FIG. 3b is a top view of the mounting apparatus shown in FIG. 3a;

FIG. 3c is a cross-sectional view of the mounting apparatus shown in and taken along line 3c-3c of FIG. 3b;

FIG. 4a is a perspective view of a mounting apparatus configured in accordance with another embodiment of the present invention;

FIG. 4b is a top view of the mounting apparatus shown in FIG. 4a;

FIG. 4c is a cross-sectional view the mounting apparatus shown in and taken along line 4c-4c of FIG. 4;

FIG. 5a is a perspective view of a mounting apparatus configured in accordance with a further embodiment of the present invention;

FIG. 5b is a top view of the mounting apparatus shown in FIG. 5a;

FIG. 5c is a cross-sectional view of the mounting apparatus shown in and taken alone line 5c-5c of FIG. 5b;

FIG. 6a is a perspective view of a mounting apparatus configured in accordance with a further embodiment of the present invention;

FIG. 6b is a top view of the mounting apparatus shown in FIG. 6a;

FIG. 6c is a cross-sectional view of the mounting apparatus shown in and taken alone line 6c-6c of FIG. 6b;

FIG. 6d is a side view of the mounting apparatus shown in FIG. 6a;

FIG. 7a is a perspective view of a mounting apparatus configured in accordance with a further embodiment of the present invention;

FIG. 7b is a top view of the mounting apparatus shown in FIG. 7a;

FIG. 7c is a cross-sectional view of the mounting apparatus shown in and taken alone line 7c-7c of FIG. 7b;

FIG. 8a is a front view of an enclosure utilizing a mounting apparatus configured in accordance with the present invention;

FIG. 8b is a cross-sectional view of the enclosure shown in and taken along line 8b-8b of FIG. 8a;

FIG. 8c is an enlarged view of the circled portion “8c” shown in FIG. 8b;

FIG. 9a is a rear view of an enclosure mountable in accordance with the present invention;

FIG. 9b is a cross-sectional of the enclosure shown in and taken along line 9b-9b of FIG. 9a;

FIG. 9c is an enlarged view of the circled portion “9c” shown in FIG. 9b;

FIG. 10a is a front view of an enclosure mountable in accordance with the present invention;

FIG. 10b is a cross-sectional of the enclosure shown in and taken along line 10b-10b of FIG. 10a; and

FIG. 10c is an enlarged view of the circled portion “10c” shown in FIG. 10b.

### DETAILED DESCRIPTION OF THE PREFERRED EMBODIMENTS

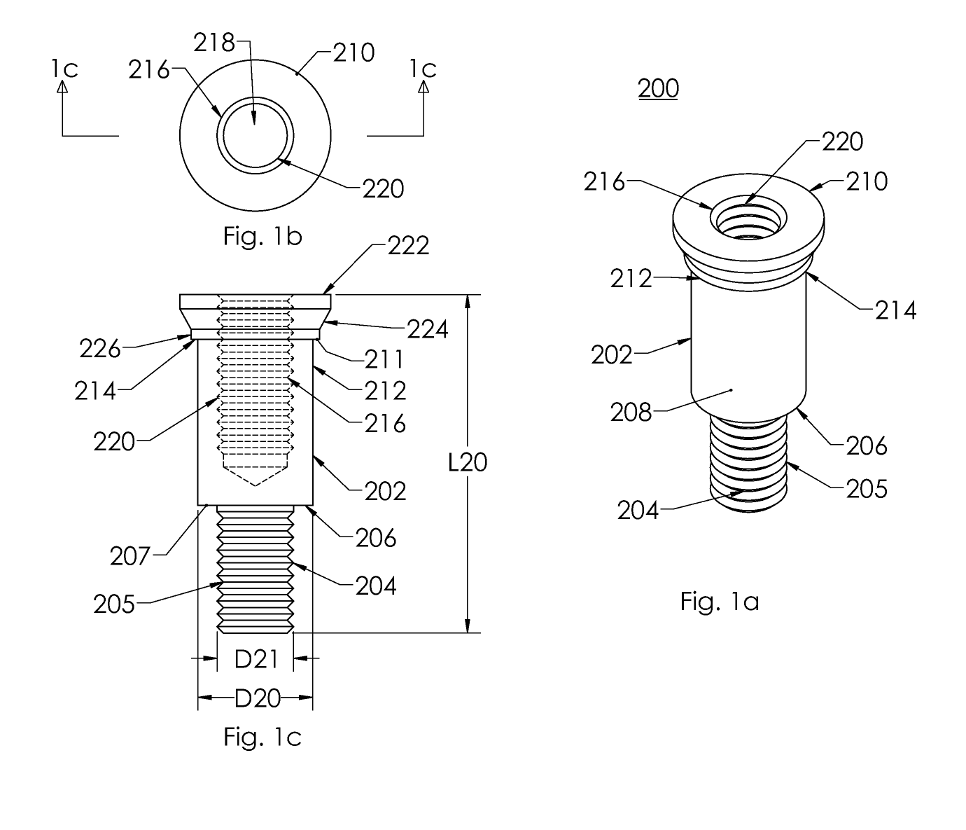

Referring now to the drawings, FIG. 1a is a perspective view of a fastener, stud, or mounting apparatus 200 configured in accordance with a preferred embodiment of the present invention. FIG. 1b is a top view of the apparatus 200, and FIG. 1c is a cross-sectional view of the apparatus 200 shown in and taken along line 1c-1c of FIG. 1b. The apparatus 200 includes a cylindrical body 202 having a diameter D20 and a length L20. The diameter D20 and the length L20 are not any particular value, but D20 typically is around half an inch, and the length L20 typically is around one inch. The body 202 preferably is cylindrical in configuration, but can be other shapes, such as rectangular.

An extension 204 is connected to a bottom 206 of the cylindrical body 202. The extension 204 preferably has a cylindrical configuration and is screw threaded on an outer surface 205 of the extension 204. The extension 204 has a diameter D21 which is less than the diameter D20 of the cylindrical body 202, thus exposing a portion of the bottom 206 to form a ridge or edge 207. The outer surface 208 of the cylindrical body 202 preferably is smooth.

A head or rim 210 is formed on top 212 of the cylindrical body 202. The top 222 and bottom 211 of the head 210 preferably are flat and extend beyond the outer surface 208 of the cylindrical body 202 to form a ridge, edge, or ledge 214. A bore 216 having an opening 218 in the head 210 extends into the cylindrical body 202. The internal surface or wall 220 of the bore 216 preferably is threaded to receive a bolt. The head 210 can be any shape, such as circular or square. In FIG. 1b the head 210 has a circular shape.

A ramp or tapered section 224 can be included to function as a transition from the width of the rim or head 210 to the width or diameter D20 of the cylindrical body 202. A smaller rim 226 can be located at the bottom 211 of the head 210. The apparatus 200 preferably is constructed as one unitary piece and made of a metal, such as stainless steel.

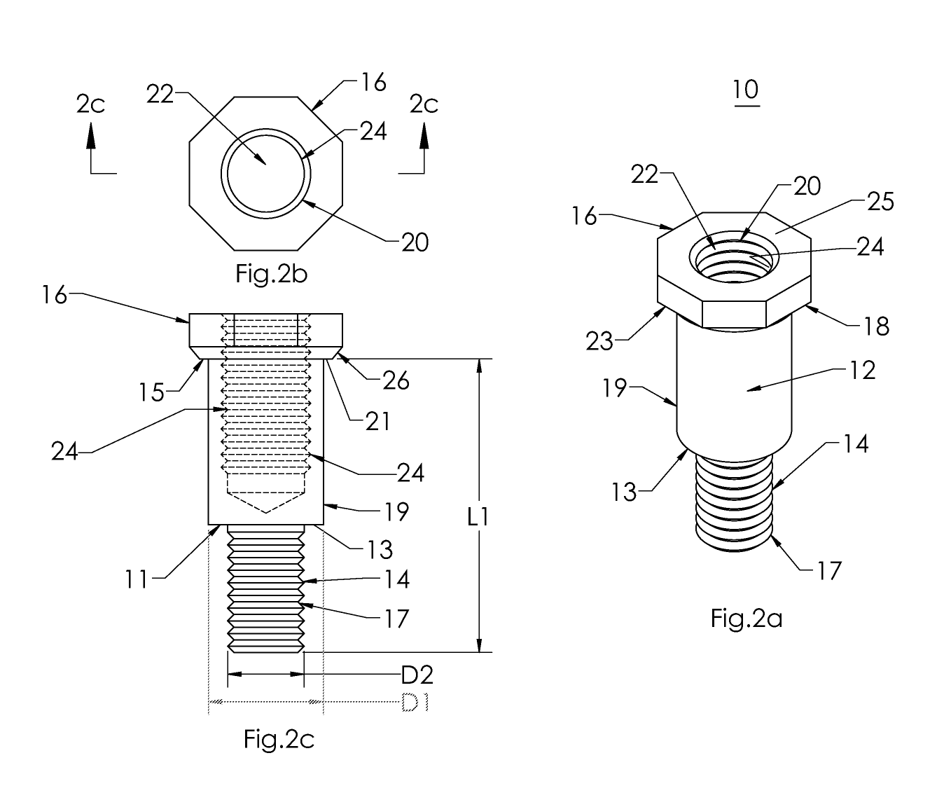

FIG. 2a is a perspective view of a fastener, stud, or mounting apparatus 10 configured in accordance with another embodiment of the present invention. FIG. 2b is a top view of the mounting apparatus 10, and FIG. 2c is a cross-sectional view of apparatus 10 taken along line 2c-2c of FIG. 2b. The apparatus 10 includes a body 12 having a first diameter D1 and a length L1. The first diameter D1 and the length L1 are not any particular value, but first diameter D1 typically is around half an inch, and the length L1 typically is around one inch. The body 12 preferably is cylindrical in configuration, but can be other shapes, such as rectangular.

An extension 14 is connected to a bottom 13 of the cylindrical body 12. The extension 14 preferably has a cylindrical configuration and is screw threaded on an outer surface 17 of the extension 14. The extension 14 has a diameter D2 which is less than the diameter D1 of the body 12, thus exposing a portion of the bottom 13 of the cylindrical body 12 to form a ridge or edge 11. The outer surface 19 of the cylindrical body 12 preferably is smooth.

A head or rim 16 is formed on top 23 of the cylindrical body 12. The top 25 and bottom 21 of the head 16 preferably are flat and extend beyond the outer surface 19 of the cylindrical body 12 to form a ridge, edge, or ledge 18. A bore 20 having an opening 22 in the head 16 extends into the cylindrical body 12. The internal surface or wall 24 of the bore 20 preferably is threaded to receive a bolt. The head 16 can be any shape, such as circular or square. In FIG. 2c, the head 16 has an octagon shape.

A ramp, slope or tapered section 26 can be included to function as a transition from the width of the head or rim 16 to the width or diameter D1 of the cylindrical body 12. The apparatus 10 preferably is constructed as one unitary piece and made of a metal, such as stainless steel.

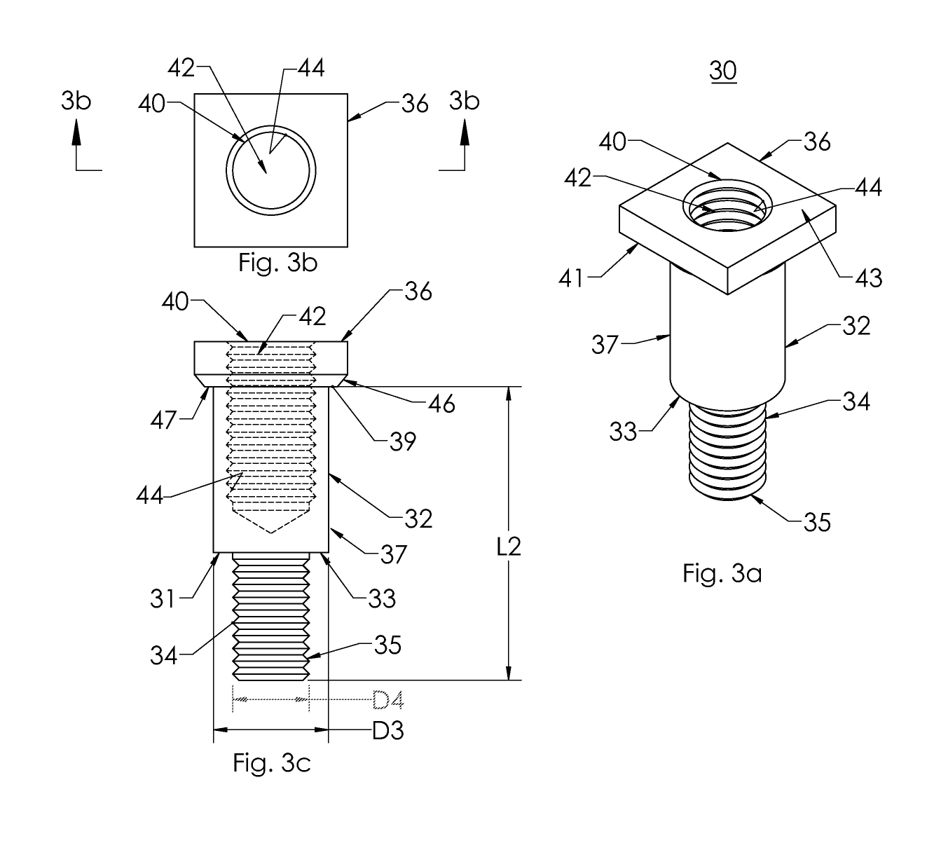

FIG. 3a is a perspective view of a mounting apparatus 30 configured in accordance with a further embodiment of the present invention. The apparatus 30 is similar to apparatus 200, except the head or rim 36 of the apparatus 30 has a square configuration instead of a round configuration like apparatus 200. FIG. 3b is a top view of the apparatus 30, and FIG. 2c is a cross-sectional view of the apparatus 30 shown in and taken along line 3c-3c of FIG. 3b. The apparatus 30 includes a cylindrical body 32 having a diameter D3 and a length L2. The diameter D3 and the length L2 are not any particular value, but D3 typically is around half an inch, and the length L2 typically is around one inch. The body 32 preferably is cylindrical in configuration, but can be other shapes, such as rectangular.

An extension 34 is connected to a bottom 33 of the cylindrical body 32. The extension 34 preferably has a cylindrical configuration and is screw threaded on an outer surface 35 of the extension 34. The extension 34 has a diameter D4 which is less than the diameter D3 of the cylindrical body 32, thus exposing a portion of the bottom 33 to form a ridge or edge 31. The outer surface 37 of the cylindrical body 32 preferably is smooth.

A head or rim 36 is formed on top 39 of the cylindrical body 32. The top 43 and bottom 41 of the head 36 preferably are flat and extend beyond the outer surface 37 of the cylindrical body 32 to form a ridge, edge, or ledge 47. A bore 40 has an opening 42 in the head 36 extending into the cylindrical body 32. The internal surface or wall 44 of the bore 40 preferably is threaded to receive a bolt. The head 36 can be any shape, such as circular or square. In FIG. 3c, the head 36 has a square shape.

A ramp or tapered section 46 can be included to function as a transition from the width of the rim 36 to the width or diameter D3 of the cylindrical body 32. The apparatus 30 preferably is constructed as one unitary piece and made of a metal, such as stainless steel.

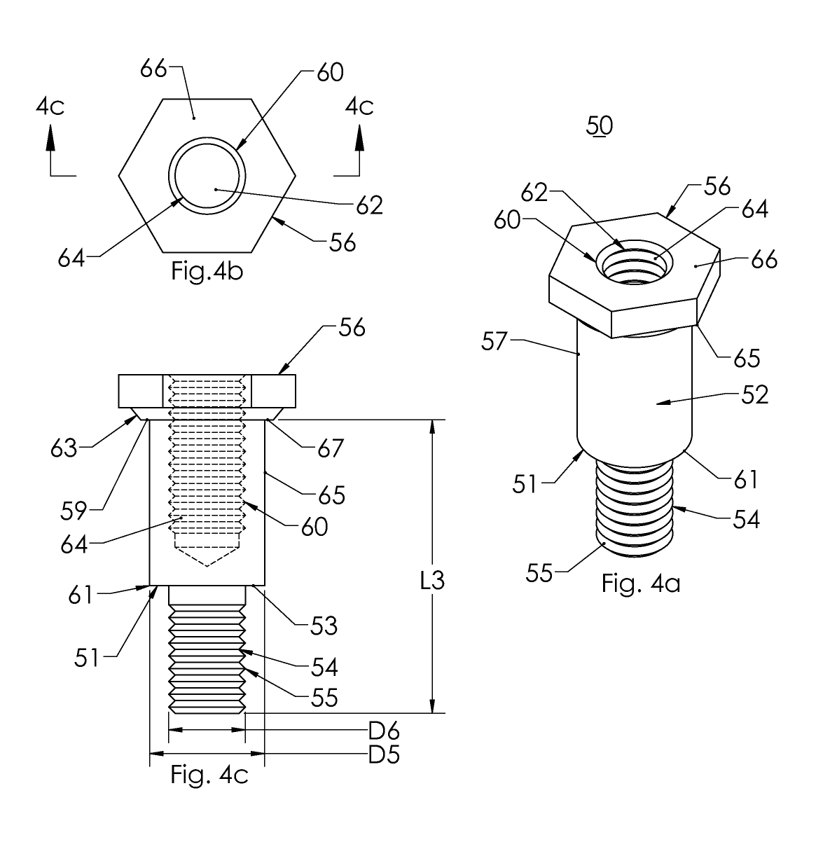

FIG. 4a is a perspective view of a mounting apparatus 50 configured in accordance with a further embodiment of the present invention. The apparatus 50 is similar to apparatus 200, except the head or rim 56 of the apparatus 50 has a hexagon configuration instead of a circular configuration like apparatus 200. FIG. 4b is a top view of the apparatus 50, and FIG. 4c is a cross-sectional view of the apparatus 50 shown in and taken along line 4c-4c of FIG. 4b. The apparatus 50 includes a cylindrical body 52 having a diameter D5 and a length L3. The diameter D5 and the length L3 are not any particular value, but D5 typically is around half an inch, and the length L3 typically is around one inch. The body 52 preferably is cylindrical in configuration, but can be other shapes, such as rectangular.

An extension 54 is connected to a bottom 53 of the cylindrical body 52. The extension 54 preferably has a cylindrical configuration and is screw threaded on an outer surface 55 of the extension 54. The extension 54 has a diameter D6 which is less than the diameter D5 of the cylindrical body 52, thus exposing a portion of the bottom 51 of the cylindrical body 52 to form a ridge or edge 61. The surface 57 of the cylindrical body 52 preferably is smooth.

A head or rim 56 is formed on top 59 of the cylindrical body 52. The top 66 and bottom 65 of the head 56 preferably are flat and extend beyond the outer surface 57 of the cylindrical body 52 to form a ridge, edge, or ledge 67. A bore 60 having an opening 62 in the head 56 extends into the cylindrical body 52. The internal surface or wall 64 of the bore 60 preferably is threaded to receive a bolt. The head 56 can be any shape, such as circular or square. In FIG. 4b, the head 56 has a hexagon shape.

A ramp or tapered section 63 can be included to function as a transition from the width of the rim 56 to the width or diameter D5 of the cylindrical body 52. The apparatus 50 preferably is constructed as one unitary piece and made of a metal, such as stainless steel.

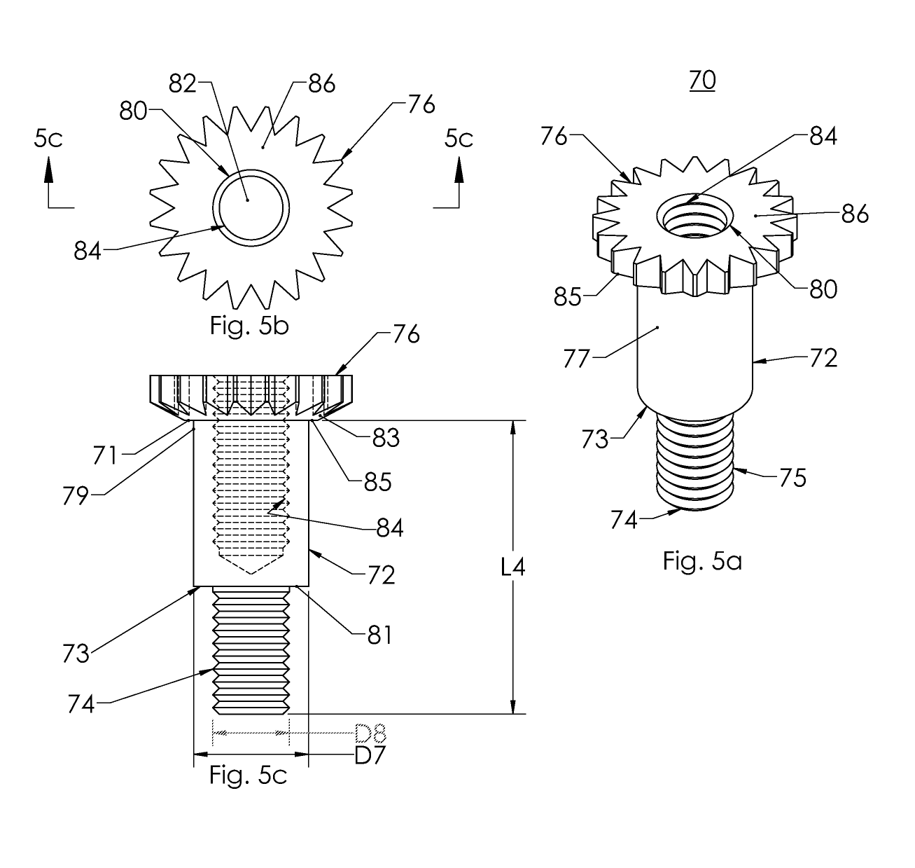

FIG. 5a is a perspective view of a mounting apparatus 70 configured in accordance with another embodiment of the present invention. The apparatus 70 is similar to apparatus 200, except the head or rim 76 of the apparatus 70 has a geared or toothed configuration, instead of a circle configuration like apparatus 200. FIG. 5b is a top view of the apparatus 70, and FIG. 5c is a cross-sectional view of the apparatus 70 shown in and taken along line 5c-5c of FIG. 5b. The apparatus 70 includes a cylindrical body 72 having a diameter D7 and a length L4. The diameter D7 and the length L4 are not any particular value, but D7 typically is around half an inch, and the length L4 typically is around one inch. The body 72 preferably is cylindrical in configuration, but can be other shapes, such as rectangular.

An extension 74 is connected to a bottom 73 of the cylindrical body 72. The extension 74 preferably has a cylindrical configuration and is screw threaded on an outer surface 75 of the extension 74. The extension 74 has a diameter D8 which is less than the diameter D7 of the cylindrical body 72, thus exposing a portion of the bottom 73 of the cylindrical body 72 to form a ridge or edge 81. The outer surface 77 of the cylindrical body 72 preferably is smooth.

A head or rim 76 is formed on top 79 of the cylindrical body 72. The top 86 and the bottom 85 of the head 76 preferably are flat and extend beyond the outer surface 77 of the cylindrical body 72 to form a ridge, edge, or ledge 71. A bore 80 having an opening 82 in the head 76 extends into the cylindrical body 72. The internal surface or wall 84 of the bore 80 preferably is threaded to receive a bolt. The head 76 can be any shape, such as circular or square. In FIG. 5b, the head 76 has a gear or toothed shape.

A ramp or tapered section 83 can be included to function as a transition from the width of the rim 76 to the width or diameter D7 of the cylindrical body 72. The apparatus 70 preferably is constructed as one unitary piece and made of a metal, such as stainless steel.

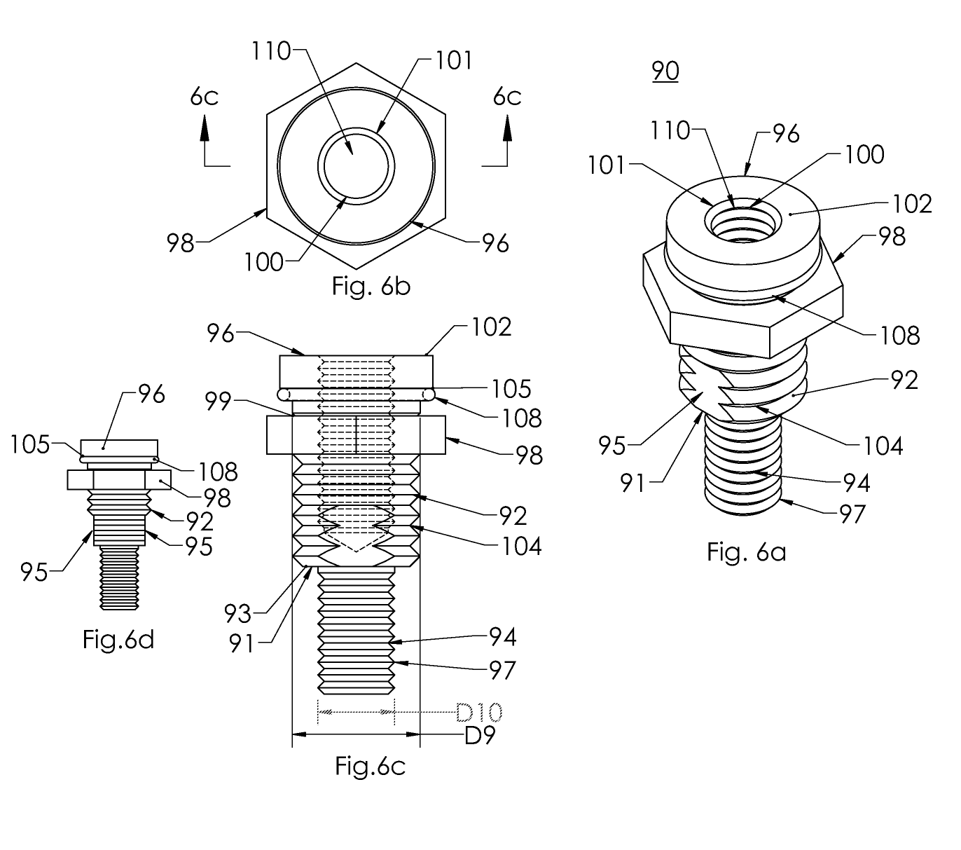

FIG. 6a is a perspective view of a mounting apparatus 90 configured in accordance with another embodiment of the present invention. FIG. 6b is a top view of the apparatus 90, and FIG. 6c is a cross-sectional view of the apparatus 90 shown in and taken along line 6c-6c of FIG. 6b. The apparatus 90 includes a partially cylindrical body 92 having a diameter D9. The body 92 preferably is at least partially cylindrical in configuration. Flat portions 95 on the outer surface 104 of the body 92 provide locations for a wrench to grip and tighten or loosen the mounting apparatus 90. FIG. 6d is a side view of the apparatus 90 illustrating the flat portions 95 of the surface 104 of the body 92.

An extension 94 is connected to a bottom 93 of the cylindrical body 92. The extension 94 preferably has a cylindrical configuration and is screw threaded on an outer surface 97 of the extension 94. The extension 94 has a diameter D10 which is less than the diameter D9 of the cylindrical body 92, thus exposing a portion of the bottom 93 to form a ridge or edge 91.

A head or rim 96 is formed on top 99 of the cylindrical body 92. The top 102 and bottom 105 of the head 96 preferably are flat and extend beyond the outer surface 104 of the cylindrical body 92 to form a ridge, edge, or ledge. A bore 100 having an opening 110 in the head 96 extends into the cylindrical body 92. The internal surface or wall 101 of the bore 100 preferably is threaded to receive a bolt. The head 96 can be any shape, such as circular or square. In FIG. 6b, the head 96 has a circular shape. The apparatus 90 preferably is constructed as one unitary piece and made of a metal, such as stainless steel.

The outer surface 104 of the cylindrical body 92, unlike apparatus 200, is screw threaded. The threading on the outer surface 104 of the cylindrical body 92 enables a nut 98 to be screwed onto the outer surface 104 of the cylindrical body 92 and tightened up against the flat bottom surface 105 or a washer 108 against the head 96. This design enables the apparatus 90 to be manually secured within a mounting hole sized for the cylindrical body 92. The washer 98 preferably is constructed of rubber or metal, and can be flat or have a circular cross-section as illustrated in FIG. 6c.

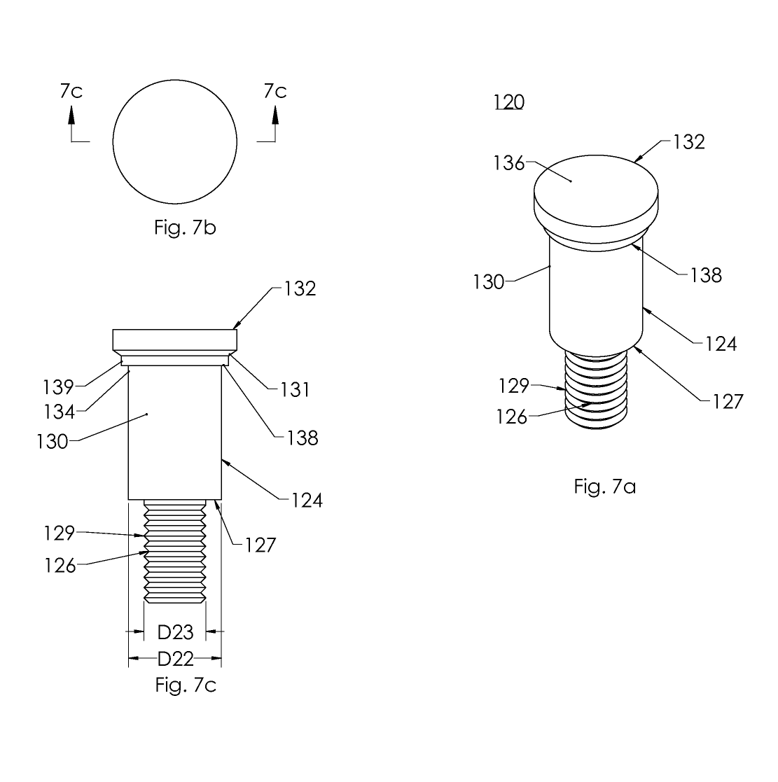

FIG. 7a is a perspective view of a mounting apparatus 120 configured in accordance with a further embodiment of the present invention. The apparatus 120 is similar to apparatus 200, except the head or rim 132 does not have bore 216. FIG. 7b is a top view of the apparatus 120, and FIG. 7c is a cross-sectional view of the apparatus 120 shown in and taken along line 7c-7c of FIG. 7b. The apparatus 120 includes a cylindrical body 124 having a diameter D22.

An extension 126 is connected to a bottom 127 of the cylindrical body 124. The extension 126 preferably has a cylindrical configuration and is screw threaded on an outer surface 129 of the extension 126. The extension 126 has a diameter D23 which is less than the diameter D22 of the cylindrical body 124, thus exposing a portion of the bottom 127 of the cylindrical body 124 to form a ridge or edge. The surface 130 of the cylindrical body 124 preferably is smooth.

A head or rim 132 is formed on a top 134 of the cylindrical body 124. The top 136 and bottom 138 of the head 132 preferably are flat and extend beyond the outer surface 130 of the cylindrical body 124 to form a ridge, edge, or ledge. The head 132 can be any shape, such as circular or square. In FIG. 7b, the head 132 has a circular shape.

A ramp, slope, or tapered section 131 can be included to function as a transition from the width of the head or rim 132 to the width or diameter D22 of the cylindrical body 124. The apparatus 120 preferably is constructed as one unitary piece and made of a metal, such as stainless steel. A smaller rim 139 can be included at the bottom 138 of the head 132. The apparatus 120 is designed to be welded within a rear wall mounting hole of a watertight enclosure like 200, but not screwed into the real wall of a watertight enclosure. Extension 126 is for mounting a back panel for electronics to the rear wall inside an enclosure.

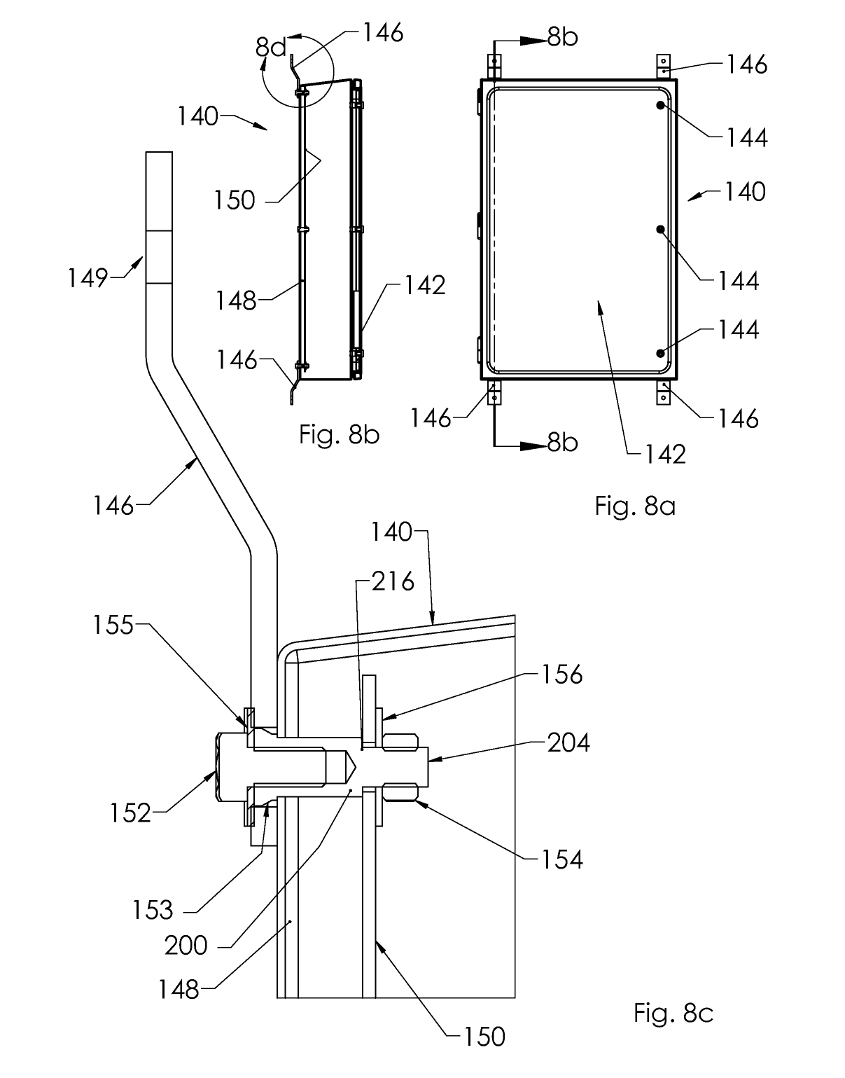

FIG. 8a is a front view of a watertight enclosure 140 to be mounted using a mounting apparatus configured in accordance with the present invention. Illustrated are a front door 142 having locking knobs 144 and rear mounting brackets 146. FIG. 8b is a cross-sectional view of the enclosure 140 and mounting brackets 146 shown in and taken along line 8b-8b of FIG. 8a. Shown in FIG. 8b are the mounting brackets 146, the front door 142, a rear wall 148 of the enclosure 140, and a rear panel 150 connected to the rear wall 148 for mounting electrical components.

FIG. 8c is an enlarged view of the circled portion “8c” shown in FIG. 8b. The enclosure 140 is shown and the mounting bracket 146 having a mounting aperture 149 in the bracket 146. The rear panel 150 is shown mounted to the back wall or rear wall 148 using the mounting apparatus 200 shown in FIGS. 1a-1c. The bracket 146 is mounted to the rear wall 148 using a bolt 152 screwed into the bore 216 of the fastener 200. The fastener 200 is mounted to the rear wall 148 of the enclosure 140 via a mounting hole 153 in the rear wall 148. A washer 155, preferably metal, is located between the head of the bolt 152 and the bracket 146. The rear panel 150 is mounted to the fastener 200 using a washer 156 and a machine or hex nut 154 located on the extension 204 of the fastener 200.

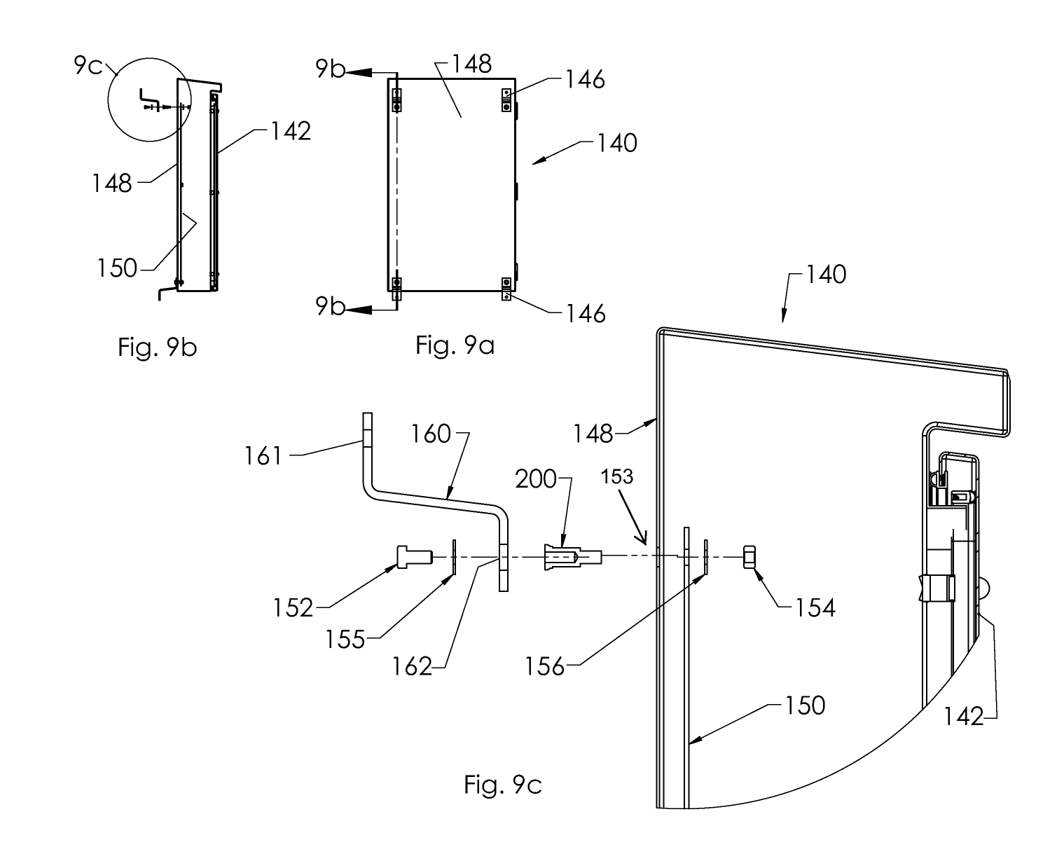

FIG. 9a is a rear view of a watertight enclosure 140 to be mounted using a mounting apparatus configured in accordance with the present invention. Illustrated are a rear wall 148 and rear mounting brackets 160. FIG. 9b is a cross-sectional view of the enclosure 140 and mounting brackets 160 shown in and taken along line 9b-9b of FIG. 9a. Shown in FIG. 9b are the mounting brackets 160, a front door 142, the rear wall 148 of the enclosure 140, and a rear panel 150 connected to the rear wall 148 for mounting electrical components.

FIG. 9c is an enlarged view of the circled portion “9c” shown in FIG. 9b, wherein the components are shown in an exploded view. The enclosure 140 is shown and the mounting bracket 160 having mounting apertures 161 and 162 in the bracket 160. The rear panel 150 is shown to be mounted to the rear wall 148 using the mounting apparatus 200 shown in FIGS. 1a-1c. The bracket 160 is mounted to the rear wall 148 using a bolt 152 screwed into the bore 216 of the fastener 200. The fastener 200 is to be mounted to the rear wall 148 of the enclosure 140 via a mounting hole 153. A washer 155, preferably metal, is to be located between the head of the bolt 152 and the bracket 160. The rear panel 150 is to be mounted to the fastener 200 using a washer 156 and a machine or hex nut 154 located on the extension 204 of the fastener 200.

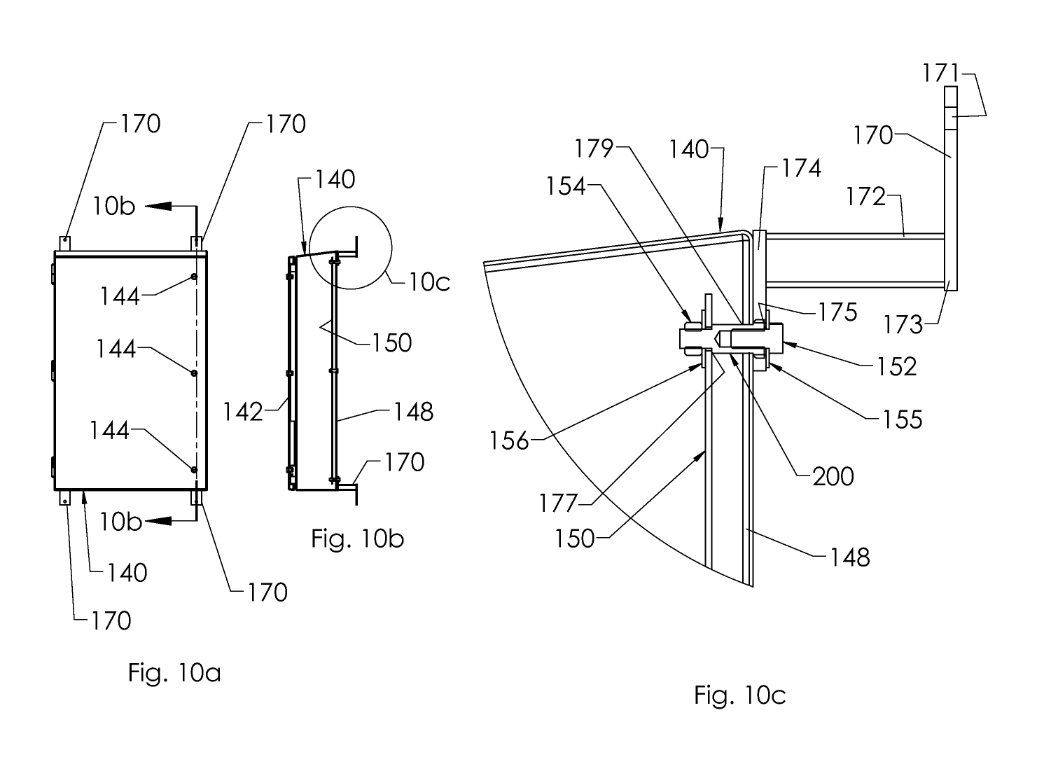

FIG. 10a is a front view of a watertight enclosure 140 to be mounted using a mounting apparatus configured in accordance with the present invention. Illustrated are a front door 142 having locking knobs 144 and rear mounting brackets 170. FIG. 10b is a cross-sectional view of the enclosure 140 and mounting brackets 170 shown in and taken along line 10b-10b of FIG. 10a. Shown in FIG. 10b are the mounting brackets 170, the front door 142, a rear wall 148 of the enclosure 140, and a rear panel 150 connected to the rear wall 148 for mounting electrical components.

FIG. 10c is an enlarged view of the circled portion “10c” shown in FIG. 10b. The enclosure 140 is shown and the mounting bracket 170 having a mounting aperture 171 in the bracket 170 for connecting the bracket 170 to a vertical wall. The rear panel 150 is shown mounted to the rear wall 148 of the enclosure 140 using the mounting apparatus 200 shown in FIGS. 1a-1c.

The bracket 170 has a first arm 173 and a second arm 174 connected by a bar 172. A first aperture 171 is for mounting the bracket to a vertical wall, and the second aperture 175 is for mounting the bracket 170 to a rear wall 148 of the enclosure 140. The bracket 170 is mounted to the rear wall 148 of the enclosure 140 using a bolt 152 screwed into the bore 216 of the fastener 200. The fastener 200 is mounted to the rear wall 148 of the enclosure 140 via the aperture 175 in the bracket 170 and an aperture 179 in the rear wall 148 of the enclosure. A washer 155, preferably metal, is located between the head of the bolt 152 and the second arm 174 of the bracket 170. The rear panel 150 is mounted to the fastener 200 using a washer 156 located against a machine or hex nut 154 located on the extension 204 of the fastener 200 which passed through an aperture 177 in the rear panel 150.

While specific embodiments have been shown and described to point out fundamental and novel features of the invention as applied to the preferred embodiments, it will be understood that various omissions and substitutions and changes of the form and details of the invention illustrated and in the operation may be done by those skilled in the art, without departing from the spirit of the invention.

1. An apparatus for mounting an enclosure, comprising:
a body have a first diameter and a top and a bottom;
a head connected to the top of the body, having a top and a bottom, and extending beyond an outer surface of the body;
a cylindrical extension on the bottom of the body having a second diameter less than the first diameter, and an outer surface of the cylindrical extension is threaded; and
said body including a threaded cylindrical bore having an opening in the top of the head and the body, and the threaded cylindrical bore extending into the body.

2. The apparatus of claim 1, wherein the threaded bore extends at least half the length of the body.

3. The apparatus of claim 1, wherein the head has a circular configuration.

4. The apparatus of claim 1, wherein an outer surface of the body has a cylindrical configuration.

5. The apparatus of claim 4, wherein the outer surface of the body is threaded.

6. The apparatus of claim 1, wherein two portions of an outer surface of the body are flat.

7. The apparatus of claim 6, wherein two portions of the outer surface of the body are circular.

8. The apparatus of claim 7, wherein the two portions of the outer surface of the body that are circular are threaded.

9. The apparatus of claim 8, further comprising:
a nut screwed onto the outer surface of the body.

10. The apparatus of claim 1, further comprising:
a washer located around the body.

11. The apparatus of claim 10, wherein the washer has a flat surface.

12. The apparatus of claim 10, wherein the washer has a circular cross-section.

13. The apparatus of claim 1, further comprising:
a transitional slope from an outer surface of the head to the outer surface of the body.

14. The apparatus of claim 1, further comprising:
an enclosure having an aperture in a back wall of the enclosure; and
the apparatus being located within the aperture in the back wall, and the head is outside the enclosure and the cylindrical extension is located inside the enclosure.

15. The apparatus of claim 14, further comprising:
a rear panel mounted to the cylindrical extension of the apparatus inside the enclosure.

16. The apparatus of claim 14, further comprising:
a bracket having an aperture; and
the bracket is secured to an outside of the back wall of the enclosure and the body of the apparatus passes through the aperture in the bracket.

17. An apparatus for mounting an enclosure, comprising:
a body have a first diameter and a top and a bottom;
a head connected to the top of the body, having a flat top and a bottom, and extending beyond an outer surface of the body; and
a cylindrical extension on the bottom of the body having a second diameter less than the first diameter, and an outer surface of the cylindrical extension is threaded.

18. The apparatus of claim 17, further comprising:
an enclosure having an aperture in a back wall of the enclosure;
the apparatus being located within the aperture in the back wall, and the head is outside the enclosure and the cylindrical extension is located inside the enclosure.

19. The apparatus of claim 18, further comprising:
a rear panel mounted to the cylindrical extension of the apparatus inside the enclosure.

20. The apparatus of claim 19, further comprising:
a bracket having an aperture; and
the bracket is secured to an outside of the back wall of the enclosure by the body of the apparatus passing through the aperture in the bracket.
